(19) United States
(12) Patent Application Publication
(10) Pub. No.: US 2018/0011956 A1
(43) Pub. Date: Jan. 11, 2018

(54) Data Injection In Emulation Without Rebooting

(71) Applicant: Mentor Graphics Corporation, Wilsonville, OR (US)

(72) Inventors: Ajay Kumar, Beaverton, OR (US); Marco Anselmo Minato, West Linn, OR (US); Veerendra Kandi, Wilsonville, OR (US); Charles W. Selvidge, Oakland, CA (US)

(73) Assignee: Mentor Graphics Corporation

(21) Appl. No.: 15/207,397

(22) Filed: Jul. 11, 2016

(51) Int. Cl. G06F 17/50; G06F 9/455

(52) U.S. Cl. CPC G06F 17/5022; G06F 9/455

(57) ABSTRACT

An emulator is configured with a circuit design model for a circuit design comprising a processor and is running with an operating system. Data are transferred from a computer to a memory in the emulator through a design-independent interface or a transaction-level interface. A software program is then activated in the emulator to enable the data to be accessed by the operating system without rebooting the emulator.

### FIELD OF THE DISCLOSED TECHNOLOGY

The present disclosed technology relates to the field of circuit design verification technology. Various implementations of the disclosed technology may be particularly useful for injecting data without rebooting the emulator.

### BACKGROUND OF THE DISCLOSED TECHNOLOGY

Modern integrated circuit designs have become extremely complex. As a result, various techniques have been developed to verify that circuit designs will operate as desired before they are implemented in an expensive manufacturing process. For example, logic simulation is a tool used for verifying the logical correctness of a hardware design. Designing hardware today involves writing a program in the hardware description language. A simulation may be performed by running that program. If the program runs correctly, then one can be reasonably assured that the logic of the design is correct at least for the cases tested in the simulation.

Software-based simulation, however, may be too slow for large complex designs such as SoC (System-on-Chip) designs. The speed of execution of a simulator drops significantly as the design size increases due to cache misses and memory swapping. Hardware emulation provides an effective way to increase verification productivity. It is based on an actual silicon implementation and performs circuit verification generally in parallel as the circuit design will execute in a real device. By contrast, a simulator performs circuit verification by executing the hardware description code serially. The different styles of execution can lead to orders of magnitude differences in execution time.

While emulation is much faster than simulation for system-on-chip designs, the typical clock speed of an emulator is still three orders of magnitude slower than that of a processor (a few MHz vs. a few GHz). In a processor-based system such as mobile devices and computers, an initial “boot sequence” needs to be completed before a processor can be used to process instructions or transactions. The boot sequence may include, for example, executing a bootloader, loading an operating system and mounting a file system. Such a boot sequence can last for tens of seconds up to several minutes. In an emulator, however, the boot sequence could require tens of minutes for a Linux operating system or many hours for an Android operating system.

The long boot time presents a challenge for developing an application software program for execution on an emulated processor-based system. The emulation-based development typically needs a multi-step preparation process. The application software is first compiled by a cross compiler in a computer. The cross compiler creates executable code for an emulator. The resulted application software is then placed into a file system image, which is usually packaged with an operating system. Finally, the package is loaded into the emulator for execution of the application software in the intended environment. As noted previously, a long boot sequence is required before the execution. This may not be a problem if the application software executes as desired. However, debugging is almost always needed for software development, which involves many edit-compile-execute cycles. Under the conventional setup, even a small change in the application software requires a long boot process. The long boot process also cannot be avoided if another application software program needs to be added for execution. Re-execution of the long boot sequence severely limits the rate of developing application software programs.

### BRIEF SUMMARY OF THE DISCLOSED TECHNOLOGY

Aspects of the disclosed technology relate to techniques for data injection in emulation. In one aspect, there is a method comprising: preparing data; transferring the data from a computer to a memory in an emulator through a design-independent interface or a transaction-level interface, wherein the emulator is configured with a circuit design model for a circuit design comprising a processor and is running with an operating system; and activating a software program in the emulator to enable the data to be accessed by the operating system without rebooting the emulator.

The data comprise an application software program. The method may further starting the application software program in the emulator. The preparing may comprise cross-compiling the application software program by the computer or a second computer.

The preparing may be performed by the computer or a second computer.

The memory may correspond to a reserved region of a physical memory in the circuit design.

The transferring may be performed after the emulator suspends emulation.

The transferring may be performed by making one or more API (application program interface) calls.

In another aspect, there is a system an emulator configured with a circuit design model for a circuit design comprising a processor and loaded with an operating system; and a computer connected to the emulator, wherein the computer is programmable to transfer data from the computer to a memory in the emulator through a design-independent interface or a transaction-level interface, and wherein the emulator has a software program that enables the data to be accessed by the operating system without rebooting the emulator.

Certain inventive aspects are set out in the accompanying independent and dependent claims. Features from the dependent claims may be combined with features of the independent claims and with features of other dependent claims as appropriate and not merely as explicitly set out in the claims.

Certain objects and advantages of various inventive aspects have been described herein above. Of course, it is to be understood that not necessarily all such objects or advantages may be achieved in accordance with any particular embodiment of the disclosed technology. Thus, for example, those skilled in the art will recognize that the disclosed technology may be embodied or carried out in a manner that achieves or optimizes one advantage or group of advantages as taught herein without necessarily achieving other objects or advantages as may be taught or suggested herein.

### BRIEF DESCRIPTION OF THE DRAWINGS

FIG. 1A shows an illustrative example of an emulation system with an emulator being coupled to targets; FIG. 1B shows an illustrative example of an emulation circuit board.

FIG. 2 illustrates a programmable computer system with which various embodiments of the disclosed technology may be employed.

FIG. 3 illustrates a flow chart describing methods of data injection in emulation that may be employed by various embodiments of the disclosed technology.

FIG. 4 illustrates a flow chart 400 describing an example of transferring data from a host workstation to an emulator through a design-independent interface.

### DETAILED DESCRIPTION OF THE DISCLOSED TECHNOLOGY

General Considerations

Various aspects of the present disclosed technology relate to techniques of data injection in emulation. In the following description, numerous details are set forth for the purpose of explanation. However, one of ordinary skill in the art will realize that the disclosed technology may be practiced without the use of these specific details. In other instances, well-known features have not been described in detail to avoid obscuring the present disclosed technology.

Some of the techniques described herein can be implemented in software instructions stored on a computer-readable medium, software instructions executed on a computer, or some combination of both. Some of the disclosed techniques, for example, can be implemented as part of an electronic design automation (EDA) tool. Such methods can be executed on a single computer or on networked computers (e.g., by one or more servers in a cloud-computing environment) connected to an emulator.

The detailed description of a method or a device sometimes uses terms like “prepare,” “transfer” and “activate” to describe the disclosed method or the device function/structure. Such terms are high-level abstractions. The actual operations or functions/structures that correspond to these terms will vary depending on the particular implementation and are readily discernible by one of ordinary skill in the art.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods.

Illustrative Emulation System

Two types of emulators have been developed. The first type is programmable logic or FPGA(field programmable gate array)-based. In an FPGA-based architecture, each FPGA chip has a network of prewired blocks of look-up tables and coupled flip-flops. A look-up table can be programmed to be a Boolean function, and each of the look-up tables can be programmed to connect or bypass the associated flip-flop(s). Look-up tables with connected flip-flops act as finite-state machines, while look-up tables with bypassed flip-flops operate as combinational logic. The look-up tables can be programmed to mimic any combinational logic of a predetermined number of inputs and outputs. To emulate a circuit design, the circuit design is first compiled and mapped to an array of interconnected FPGA chips. The compiler usually needs to partition the circuit design into pieces (sub-circuits) such that each fits into an FPGA chip. The sub-circuits are then synthesized into the look-up tables (that is, generating the contents in the look-up tables such that the look-up tables together produce the function of the sub-circuits). Subsequently, place and route is performed on the FPGA chips in a way that preserves the connectivity in the original circuit design. The programmable logic chips employed by an emulator may be commercial FPGA chips or custom-designed emulation chips containing programmable logic blocks.

The second type of emulators is processor-based: an array of Boolean processors able to share data with one another is employed to map a circuit design, and Boolean operations are scheduled and performed accordingly. Similar to the FPGA-based, the circuit design needs to be partitioned into sub-circuits first so that the code for each sub-circuit fits the instruction memory of a processor.

An emulator may operate in various modes. In an in-circuit emulation mode, the emulator is connected with a user's target system to form a prototype of the system the user is designing. The emulator typically replaces the circuit being designed for the target system, allowing system-level and software testing prior to silicon availability. Although an emulator may run up to six orders of magnitude faster than a simulator, it is often not fast enough to run at the same speed of the physical target system (a few megahertz vs hundreds of megahertz). Speed rate adapters may be introduced between the target system and the emulator. A rate adapter behaves like a buffer. It caches the signal activity from the design-under-test (DUT) at emulation speed and sends it at real-time speed to the target system. Conversely, it captures the signal activity from the target system at full speed, caches it, and then sends it back to the DUT at emulation speed. Even when a rate adapter is available, the constant evolution of speed and complexity of individual I/O protocols has made timely rate adapter development difficult.

In an acceleration mode, the physical target system is replaced by a virtual target system modelled via one of the high-level languages such as SystemVerilog, SystemC, or C++. The acceleration mode leverages the existing simulation testbench and removes the need for external rate adapters. The testbench creates test vectors and check corresponding responses of the circuit model. In addition to the elimination of speed adapters, the acceleration mode has advantages such as no hardware dependencies, the ability to use the emulator remotely, and the ability to run verification of corner cases.

The acceleration mode can be cycle-based or transaction-based. The cycle-based acceleration mode employs a signal-level or bit-level interface connecting the testbench processed by the host workstation to the design mode on the emulator. Each and every transition on each and every interface signal must be transferred between the testbench and the design model at the slow speed of the testbench simulated in the workstation. As a result, the speed of the emulator is wasted waiting to carry out these signal transfers.

The transaction-based acceleration reduces the traffic between workstation and emulator by replacing bit-by-bit exchanges with transaction exchanges. Data exchange is through so-called transactors. A transactor, consisting of a front-end proxy interface on the workstation or host computer, a back-end bus-functional model on the emulator and a physical communication channel between the host computer and the emulator, converts high-level commands from the testbench on the host computer into signal-level bit sequences required by the design-under-test model on the emulator, and vice versa. This allows data being streamed and buffered between the testbench and the design-under-test, speeding up the execution of the testbench. A design team can thus access the full performance of the emulator. In addition to performance, the transaction-based emulation eliminates the need for rate adapters. The design-under-test can connect to a “virtual device” (a software model of the device) that runs on the host computer through a transaction-level interface or to a physical device through a transaction-level interface and a “virtual device” acting as a bridging device.

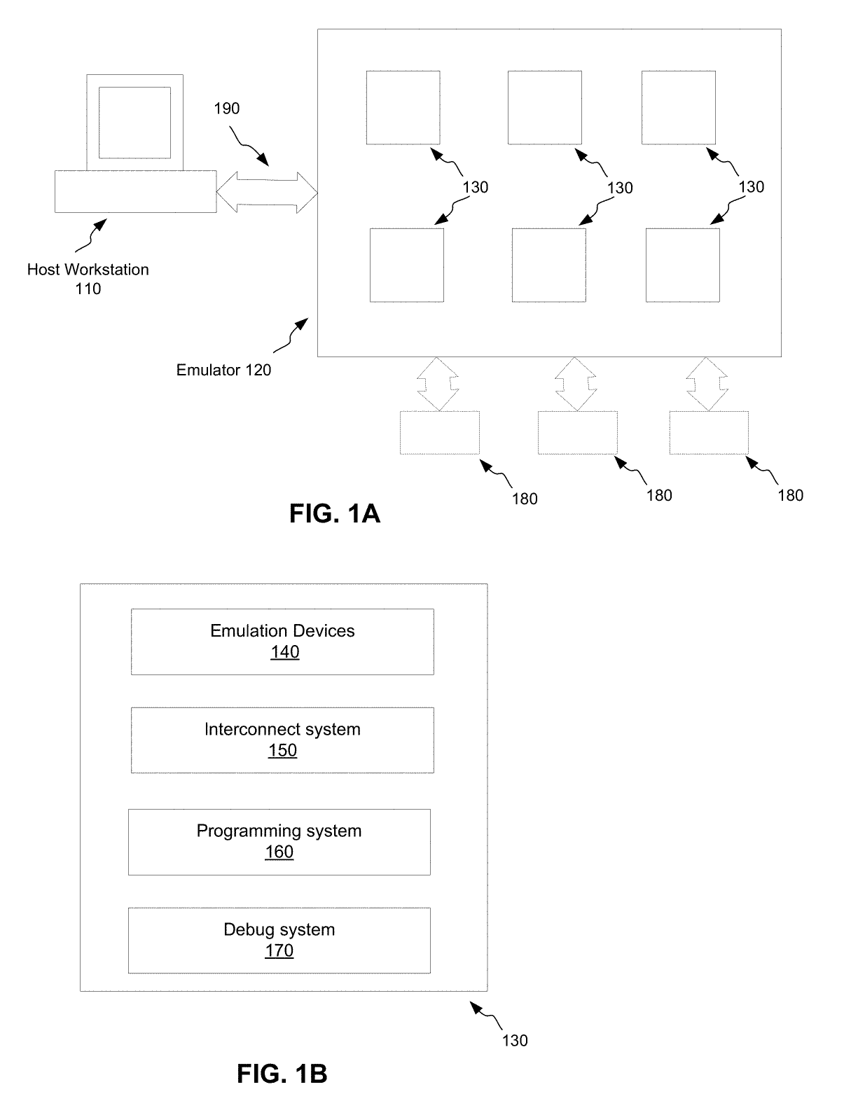

FIG. 1A shows an illustrative example of an emulation system. As seen in this figure, the emulation system includes an emulator 120 coupled to a host computer or workstation 110. The workstation may be implemented by one or more computing systems. One computing system may include a single computer or multiple computers (e.g., a master computer and a plurality of slave computers). The workstation provides the capability to load the DUV (design-under-verification, also referred to as DUT—design under test) model into the emulator, controls the execution of the DUT model on the emulator over time, and serves as a debugging interface into the DUV model on the emulator. As discussed previously, the workstation may include the testbench and perhaps other software models in some of the operational modes.

The emulator 120 includes multiple printed circuit boards (emulation circuit boards) 130. These emulation circuit boards 130 are networked (not shown). A circuit design may be partitioned by the workstation 110 and loaded to the emulation circuit boards 130 for emulation.

In the in-circuit emulation mode, one or more targets 180 are coupled to the emulator 120 in FIG. 1A. In some simple environments, a target may be a piece of test equipment that generates and verifies test data such as a network tester. In other environments, the target can be the actual circuitry with which the DUT model will interact in its final application (e.g., other hardware components of the system for which the DUT model is designed). A target can be either a static target or a dynamic target, depending on whether design clock signals run in the emulator can be suspended or not.

FIG. 1B illustrates an example of an emulation circuit board 130. The emulation circuit board 130 includes an array of emulation devices 140. The emulation devices 140 can be programmed to model, for example, combinatorial logic components, sequential circuit components and memories. The emulation devices 140 may be processor-based or FPGA-based.

Also included in the emulation circuit board 130 are an interconnect system 150, a programming system 160, and a debug system 170. The interconnect system 150 allows data to be moved between emulation devices 140. A portion of a circuit design on one emulation device may need data computed by another portion of the design on another emulation device. The programming system 160 enables a variety of other types of data to be brought in or out from an emulation device 140. Examples include programming data to configure an emulation device to perform a particular function, visibility data collected from the debug system 170 to be brought to the host workstation 110 for display, and content data either read from or written to memory circuitry in an emulation device 140. The debug system 170 enables the emulation system to monitor the behavior of a modeled circuit design. Needed data for visibility viewing purposes can be stored in the debug system 170. The debug system 170 may also provide resources for detecting specific conditions occurring in the circuit design. Such condition detection is sometimes referred to as triggering.

The emulator 120 is coupled to the host workstation 110 through an interface system 190. The interface system 190 comprises one or more interfaces. A typical interface is optimized to transport large amounts of data such as data containing the emulated circuit design model, initial contents of registers and design memories and data for debugging purposes. This interface is independent of design-under-test and may comprise dedicated logic or programmed logic in the emulator.

The interface system may also comprise one or more transaction-level interfaces. These interfaces may be optimized for small packets of data and fast streaming speed. The speed may be, for example, in the order of 2-3 Gigabits per second. The communication is performed through transactors as discussed previously. A transactor includes a back-end bus-functional model—instrumented logic in the emulator model, which requires the emulator infrastructure clock keep running even though the design clocks can be stopped.

It should also be appreciated that the emulation system in FIGS. 1A and the emulation circuit board 130 in FIG. 1B are illustrated as examples only, and they are not intended to be limiting. Various embodiments of the disclosed technology may be implemented using only a subset of the components illustrated in the figures, or include an alternate combination of components, including components that are not shown in the figures.

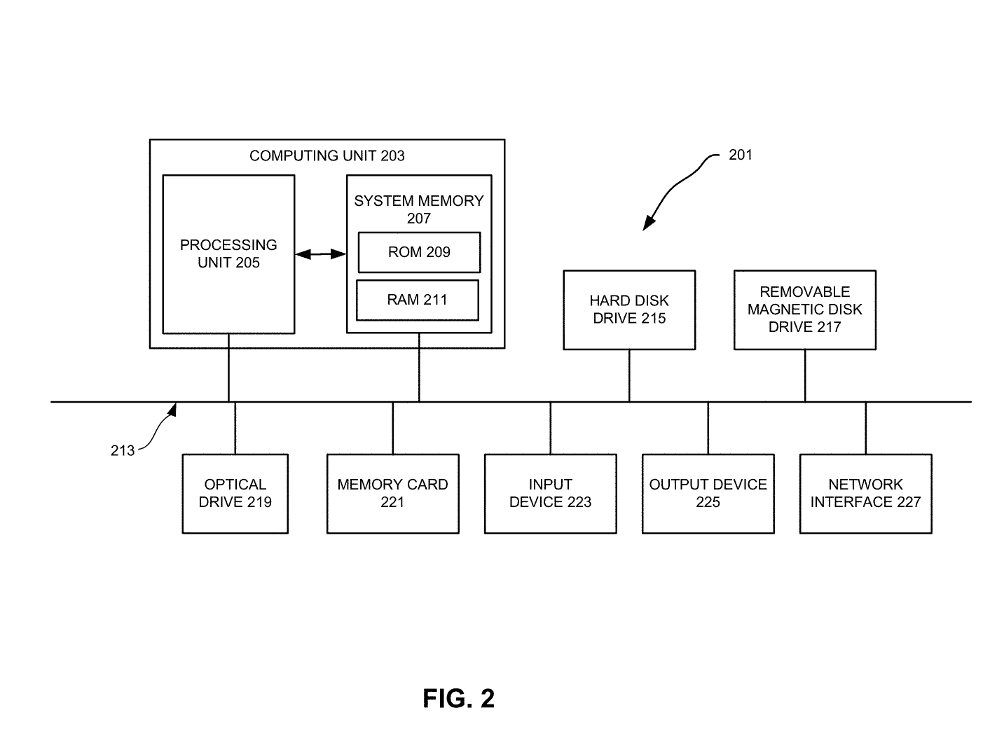

FIG. 2 shows an illustrative example of a computing device 201 that may serve as the workstation 110. As seen in this figure, the computing device 201 includes a computing unit 203 with a processing unit 205 and a system memory 207. The processing unit 205 may be any type of programmable electronic device for executing software instructions, but will conventionally be a microprocessor. The system memory 207 may include both a read-only memory (ROM) 209 and a random access memory (RAM) 211. As will be appreciated by those of ordinary skill in the art, both the read-only memory (ROM) 209 and the random access memory (RAM) 211 may store software instructions for execution by the processing unit 205.

The processing unit 205 and the system memory 207 are connected, either directly or indirectly, through a bus 213 or alternate communication structure, to one or more peripheral devices. For example, the processing unit 205 or the system memory 207 may be directly or indirectly connected to one or more additional memory storage devices, such as a “hard” magnetic disk drive 215, a removable magnetic disk drive 217, an optical disk drive 219, or a flash memory card 221. The processing unit 205 and the system memory 207 also may be directly or indirectly connected to one or more input devices 223 and one or more output devices 225. The input devices 223 may include, for example, a keyboard, a pointing device (such as a mouse, touchpad, stylus, trackball, or joystick), a scanner, a camera, and a microphone. The output devices 225 may include, for example, a monitor display, a printer and speakers. With various examples of the computer 201, one or more of the peripheral devices 215-225 may be internally housed with the computing unit 203. Alternately, one or more of the peripheral devices 215-225 may be external to the housing for the computing unit 103 and connected to the bus 213 through, for example, a Universal Serial Bus (USB) connection.

With some implementations, the computing unit 203 may be directly or indirectly connected to one or more network interfaces 227 for communicating with other devices making up a network. The network interface 227 translates data and control signals from the computing unit 203 into network messages according to one or more communication protocols, such as the transmission control protocol (TCP) and the Internet protocol (IP). Also, the interface 227 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computer 201 is illustrated as an example only, and it not intended to be limiting. Various embodiments of the disclosed technology may be implemented using one or more computing devices that include the components of the computer 201 illustrated in FIG. 2, which include only a subset of the components illustrated in FIG. 2, or which include an alternate combination of components, including components that are not shown in FIG. 2. For example, various embodiments of the disclosed technology may be implemented using a multi-processor computer, a plurality of single and/or multiprocessor computers arranged into a network, or some combination of both.

Data Injection Through Backdoor Memory Access

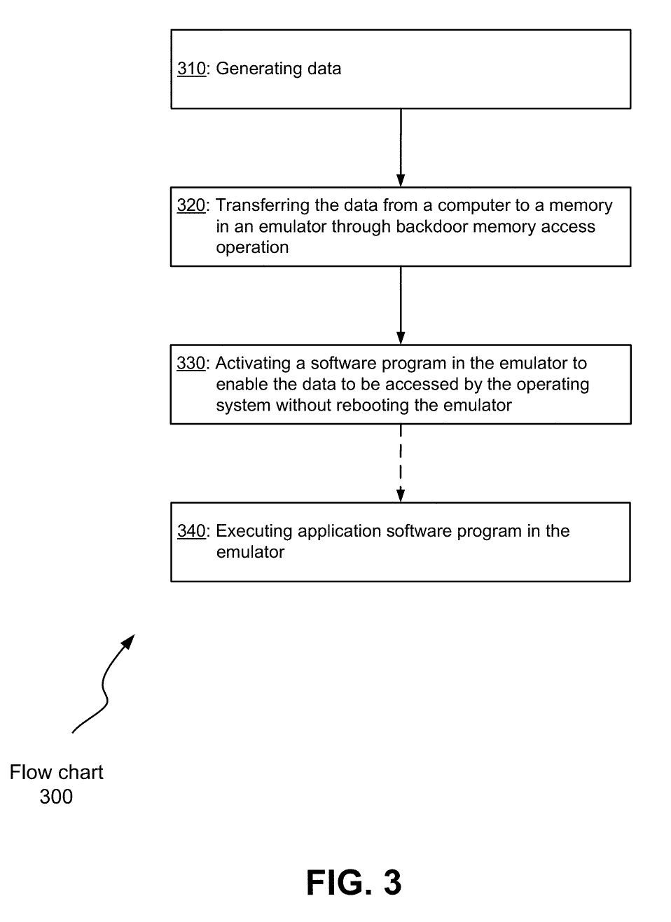

FIG. 3 illustrates a flow chart 300 describing methods for data injection that may be employed by various embodiments of the disclosed technology. For ease of understanding, the flow chart 300 will be described with reference to the emulator system illustrated in FIG. 1A. It should be appreciated, however, that alternate implementations of an emulator system may be used to perform the method of testbench restoration based on capture and replay shown in the flow chart 300 according to various embodiments of the disclosed technology. In addition, it should be appreciated that implementations of the emulator system illustrated in FIG. 1A may be employed with other methods of testbench restoration based on capture and replay according to different embodiments of the disclosed technology.

In operation 310 of the flowchart 300, a computer prepares data to be transferred to the emulator 120. The computer may be the workstation 110 or a different computer. The emulator 120 is configured with a circuit design model for a circuit design. The circuit design comprises a processor and the emulator 120 is running with an operating system. The preparation may comprise formatting the data to match the requirements of the emulator. The requirements may, for example, specify repeating address and data fields.

With various implementations of the disclosed technology, the data may comprise an application software program intended to be run by the circuit design model on the emulator 120. The application software program is often generated in a computer running with an operating system different from the operating system running in the emulator 120. For example, a computer for editing the program may use a Microsoft Windows operating system for personal computers while the operating system loaded in the emulator 120 may be an Android operating system for mobile devices. The preparation may thus comprise a cross-compiler that compiles the application software program for running in the Android operating system.

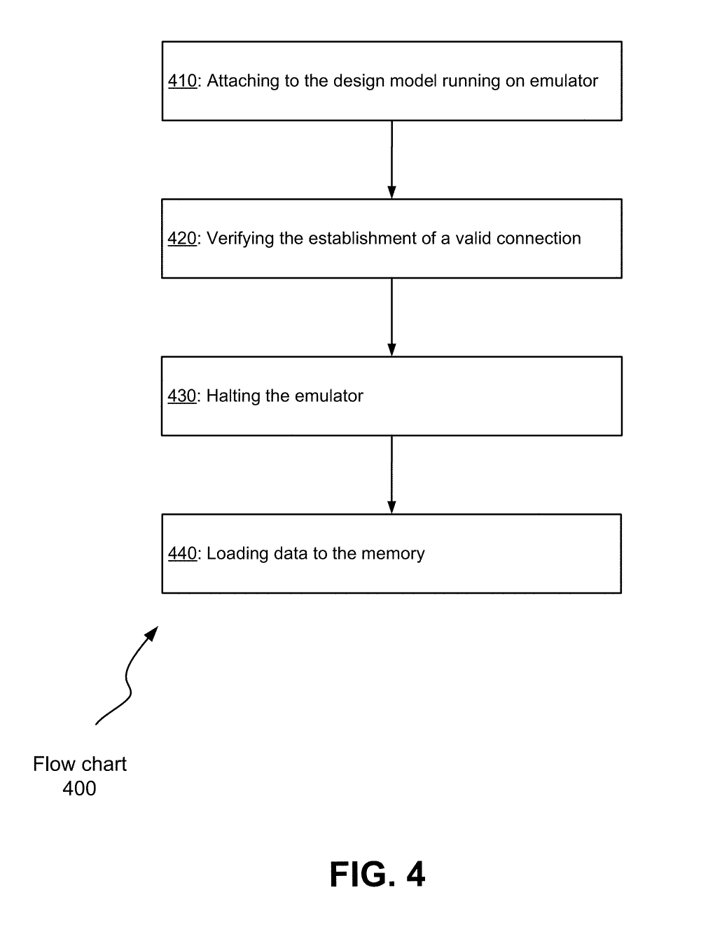

In operation 320, the data are transferred from the workstation 110 to a memory in the emulator 120 through a design-independent interface or a transaction-level interface. As noted previously, the design-independent interface may be the one for loading circuit design model into the emulator 110. To use the interface, the workstation 110 may make one or more API (application program interface) calls. FIG. 4 illustrates a flow chart 400 describing an example of transferring data from the workstation 110 to the emulator 120 through the design-independent interface. In operation 410, an API call enables the circuit design model running on the emulator 120 to be attached. In operation 420, the establishment of a valid connection is verified. In operation 430, the emulator is halted. In operation 440, the data are loaded to the memory by executing a Tcl (Tool Command Language) script.

The transaction-level interface may also be employed for the data transfer. As noted previously, the transfer is accomplished through a transactor. The front-end proxy interface of the transactor is typically a behavior model that runs on the workstation 110. One or more API calls associated with the transactor may be employed for the transfer.

The memory may be a reserved region of physical memory in the circuit design that is not used by the operating system. In the Linux operating system, the reservation can be accomplished by adjusting the range(s) of the declared memory system(s) in the file known as the Device Tree.

During the data transfer, emulation of the circuit design model may be halted as in the operation 430 of the flowchart 400. After the data transfer is finished, the emulator 120 is notified to continue its emulation.

In operation 330, a software program is activated in the emulator 120 to enable the data to be accessed by the operating system without rebooting the emulator. The software program can access the memory where the data are stored. With various implementations of the disclosed technology, the software program may also be able to interpret contents of a metadata block in the memory that describe attributes of the data being transferred such as file name and file size, and to return contents in a data block in the memory in response to read operations performed in the operating system. The software program may be added to the operating system before the operating system is loaded onto the emulator or may be installed after the operating system boots up in the emulator. In a Linux operating system, the software program may present itself as a character or block driver.

In operating 340, if the transferred data comprise an application software program, the application software program is started. Various debugging operation may be performed.

### CONCLUSION

While the disclosed technology has been described with respect to specific examples including presently preferred modes of carrying out the disclosed technology, those skilled in the art will appreciate that there are numerous variations and permutations of the above described systems and techniques that fall within the spirit and scope of the disclosed technology as set forth in the appended claims. For example, while specific terminology has been employed above to refer to electronic design automation processes, it should be appreciated that various examples of the disclosed technology may be implemented using any desired combination of electronic design automation processes.

What is claimed is:

1. A method, comprising:
preparing data;
transferring the data from a computer to a memory in an emulator through a design-independent interface or a transaction-level interface, wherein the emulator is configured with a circuit design model for a circuit design comprising a processor and is running with an operating system; and
activating a software program in the emulator to enable the data to be accessed by the operating system without rebooting the emulator.

2. The method recited in claim 1, wherein the data comprise an application software program.

3. The method recited in claim 2, further comprising:
starting the application software program in the emulator.

4. The method recited in claim 2, wherein the preparing comprises cross-compiling the application software program by the computer or a second computer.

5. The method recited in claim 1, wherein the preparing is performed by the computer or a second computer.

6. The method recited in claim 1, wherein the memory corresponds to a reserved region of a physical memory in the circuit design.

7. The method recited in claim 1, wherein the operating system is a Linux or Linux-based operating system and the software program presents itself as a character or block driver to the operating system.

8. The method recited in claim 1, wherein the transferring is performed after the emulator suspends emulation.

9. The method recited in claim 1, wherein the transferring is performed by making one or more API (application program interface) calls.

10. A system, comprising:
an emulator configured with a circuit design model for a circuit design comprising a processor and loaded with an operating system; and
a computer connected to the emulator,
wherein the computer is programmable to transfer data from the computer to a memory in the emulator through a design-independent interface or a transaction-level interface, and wherein the emulator has a software program that enables the data to be accessed by the operating system without rebooting the emulator.

11. The system recited in claim 10, wherein the data comprise an application software program.

12. The system recited in claim 11, wherein the application software program is derived using a cross-compiler in the computer or another computer.

13. The system recited in claim 10, wherein the memory corresponds to a reserved region of physical memory in the circuit design.

14. The system recited in claim 10, wherein the operating system is a Linux or Linux-based operating system and the software program presents itself as a character or block driver to the operating system.
